(19) United States
(12) Patent Application Publication
(10) Pub. No.: US 2004/0137965 A1
(43) Pub. Date: Jul. 15, 2004

(54) Folder-type communication apparatus

(75) Inventors: In-Gon Park, Seoul (KR); Jung-Hyeok Im, Songnam-shi (KR); Ji-Young Lee, Jeju-shi (KR); Sung-Kwon Kim, Seoul (KR); Sang-Min Hyun, Koyang-shi (KR); Seung-Min Park, Seoul (KR); Mitsuhiro Shigeri, Yokohama (JP)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., GYEONGGI-DO (KR)

(21) Appl. No.: 10/724,671

(22) Filed: Dec. 1, 2003

(30) Foreign Application Priority Data
Dec. 3, 2002 (KR) 76199/2002

(51) Int. Cl. H04M 1/00; H04B 1/38

(52) U.S. Cl. 455/575.1; 455/566

(57) ABSTRACT

A folder-type communication apparatus comprising a first housing having an open space and a pair of hinge supports, the open space having at least one opening, the hinge supports extending longitudinally and surrounding both opposite sides of the open space, a hinge axis extending across the open space, a second housing having upper and lower surfaces, rotatably connected to the first housing, the lower surface being provided with a first display, and a third housing having upper and lower surfaces, extending in a longitudinal direction of the second housing to be accommodated in the open space so that the third housing is capable to rotate about the hinge axis, wherein the second display is always exposed regardless of an open and close state of the second housing.

### PRIORITY

This application claims priority to an application entitled “Folder-Type Communication Apparatus” filed in the Korean Industrial Property Office on Dec. 3, 2002 and assigned Serial No. 2002-76199, the contents of which are hereby incorporated by reference.

### BACKGROUND OF THE INVENTION

1. Field of the Invention

The present invention relates generally to a portable communication apparatus such as a personal digital assistant (PDA), a hand held phone (HHP), a cellular phone, etc., and more particularly to a folder-type communication apparatus in which it is convenient to check data displayed on a display, wherein the data is frequently checked.

2. Description of the Related Art

In general, a “portable communication apparatus” is an apparatus with which a user can wirelessly communicate with a counterpart. This portable communication apparatus is classified into various types based on its physical characteristics. For example, a wireless terminal is commonly classified into a bar-type, a flip-type, or a folder-type terminal. The bar-type wireless terminal has a single housing is constructed in a bar shape. The flip-type wireless terminal has a flip is pivotably connected to a single bar-shaped housing by a hinge device. The folder-type wireless terminal has a folder is pivotably coupled to a single bar-shaped housing by a hinge device, which enables the folder to be folded.

Further, the portable wireless terminal may be classified into a neck wearable type or a wrist wearable type according to a physical wearable position. The neck wearable type wireless terminal is a type in which a user wears it around the neck using a string, while the wrist wearable type wireless terminal is a type in which a user wears it around the wrist.

In addition, the wireless terminal may be classified into a rotation-type or a sliding-type terminal based on the manner in which it opens and closes. The rotation-type wireless terminal is a type of terminal in which two housings are coupled to each other in a manner in which one housing can rotate about the other to be opened and closed. The sliding-type wireless terminal is a type of terminal in which two housings are coupled to each other in a manner in which one housing can slide on the other to be opened and closed. The above-described wireless terminals are easily understood by those skilled in the art.

Of the conventional communication apparatuses classified based on their physical appearances, the folder-type communication apparatus will be illustrated herein. Typically, the known folder-type communication apparatus includes a main housing, a folder, and a hinge module connecting the folder to the main housing to be rotatable in a direction of moving towards or away from the main housing. The main housing has an upper surface including a plurality of keys and a microphone, and has a lower surface including a speaker device and a display. The construction of this known folder-type communication apparatus is easily understood by those skilled in the art.

However, the conventional folder-type communication apparatus has a problem in that, when the folder is closed on the main housing, there is a difficulty in checking data on the display when it is covered by the folder, especially in checking data, which needs to be checked frequently. This leads to another problem in that a user suffers a trouble to open the folder from the main housing to check the data. Here, the type of data which needs to be checked frequently can include an icon indicating a receivable sensitivity of an antenna, an icon indicating a remaining power quantity of an battery, an icon informing an arrival of a character message, a date, a time, etc.

### SUMMARY OF THE INVENTION

Accordingly, the present invention has been designed to solve the above and other problems occurring in the prior art, and an object of the present invention is to provide a portable communication apparatus capable of easily checking various data and icons which are frequently used regardless of the opening/closing of a second housing, and thereby more conveniently enabling use of the portable communication apparatus.

In order to accomplish the above and other objects, there is provided a portable communication apparatus comprising: a first housing including an open space and a pair of hinge supports, the open space having at least one opening, the hinge supports extending longitudinally and surrounding opposite sides of the open space; a hinge axis extending across the open space; a second housing including upper and lower surfaces, rotatably connected to the first housing, the lower surface being provided with a first display; and a third housing including upper and lower surfaces, extending in a longitudinal direction of the second housing to be accommodated in the open space, enabling the third housing to rotate about the hinge axis, whereby the second display is always exposed regardless of an open and close state of the second housing.

### BRIEF DESCRIPTION OF THE DRAWINGS

The above and other objects, features, and advantages of the present invention will be more apparent from the following detailed description taken in conjunction with the accompanying drawings, in which:

FIG. 1 is a perspective view of a folder-type communication apparatus according to a preferred embodiment of the present invention, in which a second housing is closed;

FIG. 2 is a perspective view of a folder-type communication apparatus according to a preferred embodiment of the present invention, in which a second housing is opened;

FIG. 3 is a front view of the folder-type communication apparatus illustrated in FIG. 2;

FIG. 4 is a bottom view of the folder-type communication apparatus illustrated in FIG. 1;

FIG. 5 is a top view of the folder-type communication apparatus illustrated in FIG. 1; and

FIG. 6 is a side view of the folder-type communication apparatus illustrated in FIG. 1.

### DETAILED DESCRIPTION OF THE PREFERRED EMBODIMENT

Preferred embodiments of the present invention will be described in detail herein below with reference to the accompanying drawings. In the following description of the present invention, a detailed description of known functions and configurations incorporated herein will be omitted when it may make the subject matter of the present invention rather unclear.

It will be noted that a portable communication apparatus according to the present invention is designed so that a second display is always exposed regardless of an open and close state of a second housing, and thus it is easy to check data displayed on the display.

In addition, it should be noted that the portable communication apparatus according to the present invention falls into the category of a folder-type communication apparatus. The typical construction of known folder-type communication apparatus will not be described, because it is easily understood and known by those skilled in the art.

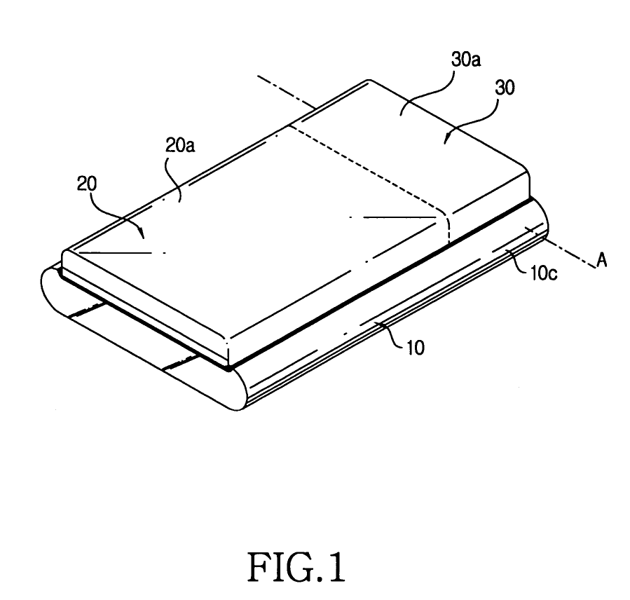

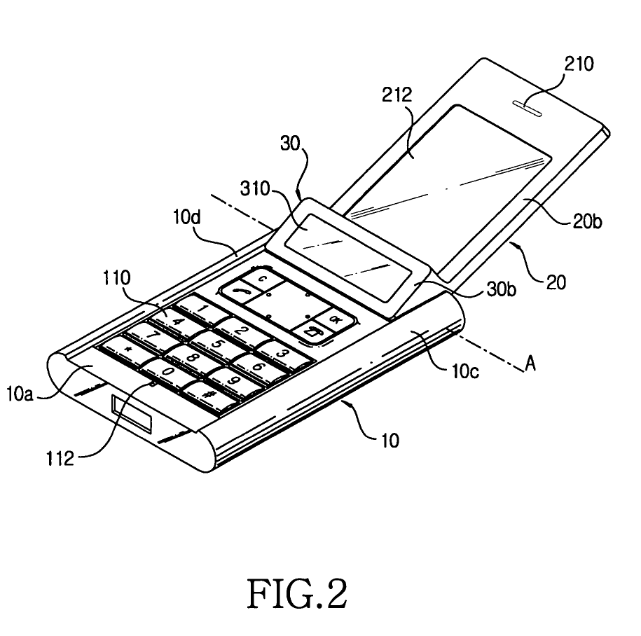

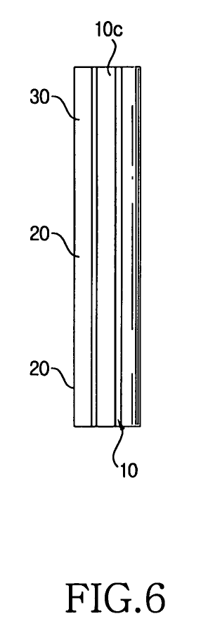

As illustrated in FIGS. 1 to 6, a portable communication apparatus according to a preferred embodiment of the present invention includes a first housing 10 formed with an open space 10e having at least one opening or opened end, a second housing 20 connected to the first housing 10 while being rotatable about a hinge axis A, rotating toward and away from the first housing 10, and a third housing 30 rotatably installed in the open space 10e.

The first housing 10 includes the open space 10e and also a pair of hinge supports 10c extending longitudinally and surrounding opposite sides of the open space 10e. The pair of hinge supports 10c is provided to connect the third housing 30, which will be described in more detail below, to the first housing 10. The first housing 10 has an upper surface 10a arranged with a plurality of keys 110 and a microphone 112.

The second housing 20 has a flat upper surface 20a and a lower surface 20b on which a first display 212 and a speaker device 210 are disposed. The first display 212 may be a typical LCD or a display capable of functioning as even a touch screen.

The third housing 30 has an upper surface 30a and a lower surface 30b, in which the upper surface 30a is flat, and the lower surface 30b is provided with a second display 310. The third housing 30 extends from the second housing 20 in a longitudinal direction. The third housing 30 is constructed in such a way that it can be accommodated in the open space 10e to rotate about the hinge axis A. That is, the hinge axis A extends across the open space 10e through the hinge supports 10c, and thus hinge axis A passes through the third housing 30, which is accommodated in the open space 10e in a transverse direction.

The third housing 30 is integrally formed by injection molding on one side of the second housing 20, so as to be protruded from the lower surface 20b of the second housing 20 in a stepped shape.

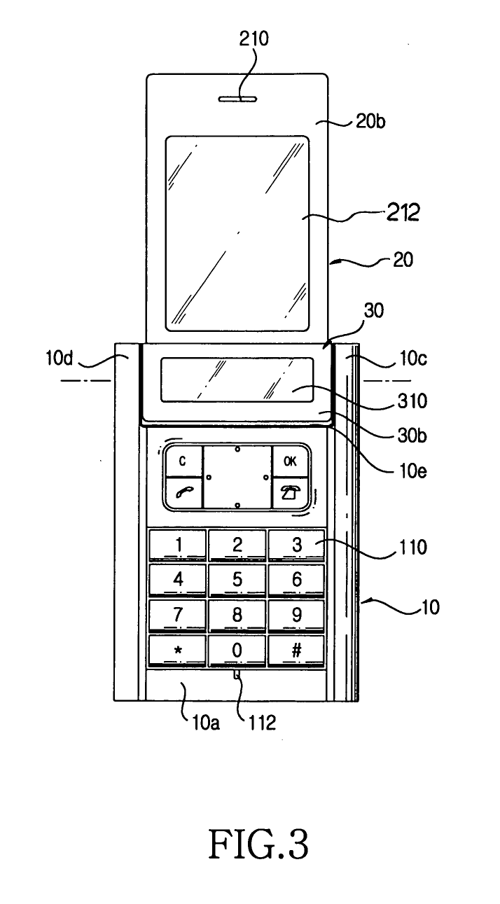

As illustrated in FIG. 3, when the second housing 20 is opened from the first housing 10, the first and second displays 212 and 310 face toward a user.

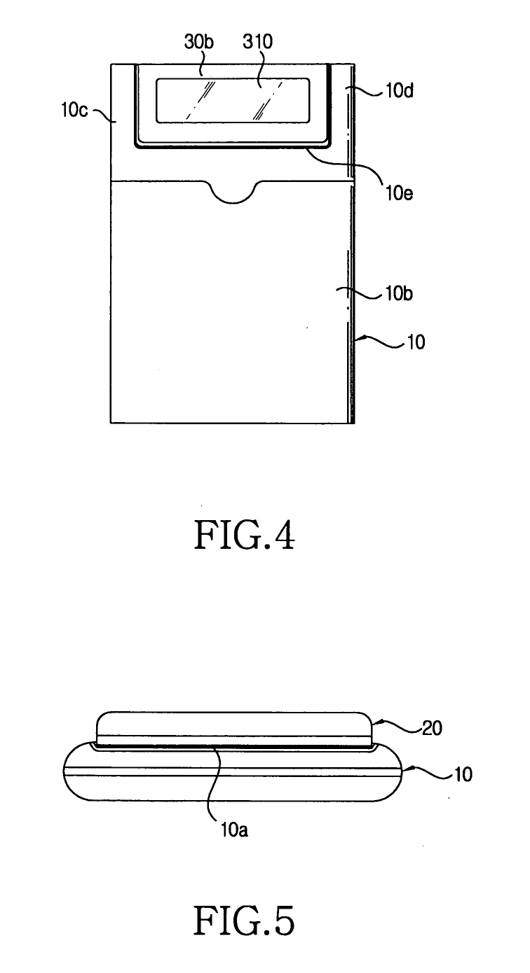

As illustrated in FIG. 4, when the second housing 20 is closed on the first housing 10, the second display 310 faces toward the lower surface 10b of the first housing 10. As a result, the second display 310 is exposed outside. Further, the first display 212 is not shown and at the same time the third housing 30 is completely accommodated in the opining space 10e.

In addition, it is preferred that various data is represented on the second display 310. Here, the various data can include a first icon for indicating a receivable sensitivity of an antenna, a second icon for indicating a remaining power quantity of an battery, a third icon for informing an arrival of a character message, a date, a time, etc. These types of data would be displayed on the second display 310 because a user can easily check the data without opening the second housing 20 even when the second housing 20 is closed on the first housing 10.

In addition, the second display 310 may be a typical LCD or a display capable of functioning as even a touch screen.

While the present invention has been shown and described with reference to certain preferred embodiments thereof, it will be understood by one skilled in the art that various modifications may be made therein without departing from the spirit and scope of the invention as defined by the appended claims.

As can seen from the foregoing, the portable communication apparatus according to the present invention is designed so that the second display is always exposed to the external environment regardless of the open and close state of the second housing. therefore, is more convenient to use than the portable terminals in the prior art.

What is claimed is:

1. A portable communication apparatus, comprising:
a) first housing including an open space and a pair of hinge supports, the open space having at least one opening, the hinge supports extending longitudinally and surrounding opposite sides of the open space;
b) a hinge axis extending across the open space;
c) a second housing including a first display, rotatably connected to the first housing to open from and close to the first housing; and
d) a third housing including a second display, extending in a longitudinal direction of the second housing to be accommodated in the open space to enable the third housing to rotate about the hinge axis;
wherein the second display is always exposed regardless of an open and close state of the second housing to the first housing.

2. The portable communication apparatus according to claim 1, wherein the first housing has an upper surface including a plurality of keys and a microphone, and wherein the second housing has the lower surface including a speaker device.

3. The portable communication apparatus according to claim 1, wherein the third housing is integrally connected to the second housing.

4. The portable communication apparatus according to claim 1, wherein the lower surface of the third housing protrudes from the lower surface of the second housing in a stepped shape.

5. A portable communication apparatus, comprising:
a) first housing including an open space and a pair of hinge supports, the open space having at lest one opening, the hinge supports extending longitudinally and surrounding opposite sides of the open space;
b) a hinge axis extending across the open space;
c) a second housing including a first display and a second display;
wherein said first display and said second display are looked upward the same direction, and said second display is always exposed regardless of an open and close state of the second housing to the first housing.

6. The portable communication apparatus according to claim 5, wherein the first housing has an upper surface including a plurality of keys and a microphone, and wherein the second housing has the lower surface including a speaker device.

7. The portable communication apparatus according to claim 5, wherein the third housing is integrally connected to the second housing.

8. The portable communication apparatus according to claim 5, wherein the lower surface of the third housing protrudes from the lower surface of the second housing in a stepped shape.
